(19) United States
(12) Patent Application Publication
(10) Pub. No.: US 2004/0028411 A1
(43) Pub. Date: Feb. 12, 2004

(54) System and method for transmitting high-bandwidth signals over a satellite communications system

(75) Inventor: Jaime Londono, Oakburst, NJ (US)

Correspondence Address: FLESHNER & KIM, LLP, P.O. BOX 221200, CHANTILLY, VA, 20153, US

(73) Assignee: SES-Americom, Incorporated

(21) Appl. No.: 10/213,105

(22) Filed: Aug. 7, 2002

(51) Int. Cl. H04B 10/00

(52) U.S. Cl. 398/121

(57) ABSTRACT

A system for communicating signals over a satellite makes more efficient use of bandwidth compared with conventional systems. In one embodiment, the system converts an optical signal having a first bit-rate format into a plurality of signals, each having a bit-rate format smaller than the first bit-rate format and thus smaller transmission bandwidths than the initial optical signal. The converted signals are then modulated and transmitted to a satellite over a predetermined frequency band. The satellite includes a first transponder having an operating bandwidth substantially equal to the transmission bandwidth of at least two of the transmitted signals, and a second transponder having an operating bandwidth sufficient to receive remaining ones of the transmitted signals. In one preferred embodiment, the higher bit-rate format signal is an OC-3 signal, the lower bit-rate format signals are OC-1/STS-1 signals, and the first and second satellite transponders have 36 MHz operating bandwidths. Given these parameters, the system communicates information using less bandwidth than is required by conventional systems.

### BACKGROUND OF THE INVENTION

1. Field of the Invention.

This invention generally relates to satellite communications systems, and more particularly to a system and method for transmitting broadband, high bit-rate signals over a satellite system which supports simplex or duplex communications.

2. Description of the Related Art

The Internet and other modem communications networks have necessitated the development of techniques for transmitting high-speed, broadband signals. One technique involves transmitting these signals over integrated services data network or so-called ISDN lines. Another, more preferred technique involves transmitting high-speed signals over fiber-optic networks such as SONET-ring networks. This latter approach has proven particularly useful for transoceanic data services.

Various formats exist for transmitting signals on a fiber-optic network which conforms to the SONET standard. These formats are expressed as optical carrier (OC) standards, each of which identifies a particular transmission speed (orbit rate). Some common standards are shown below along with their speeds in Megabits per second (Mbps):

| Standard | Speed |
|---|---|
| OC-1 | 51.84 |
| OC-3 | 155.52 |
| OC-12 | 622.08 |
| OC-24 | 1,244 |
| OC-48 | 2,488 |
| OC-192 | 9,952 |

The OC-3 standard has proven to be the format of choice for many data transmission applications. An OC-3 signal which uses the Asynchronous Transfer Mode format is shown in FIG. 1. This is a 155.52 Megabits/sec signal organized into 125 msec frames, with one frame being illustrated. In FIG. 1, the OC-3 frame is shown as being divided into nine blocks (or lines) with the blocks being transmitted serially. Each line includes part of the frame overhead and part of a payload envelope. In particular, each line includes nine section and line overhead bytes, one path overhead byte, and 260 payload bytes. The overhead bytes may be used for operation administration and maintenance purposes. When the OC-3 signal is converted to electrical form, it is known as an STS-3 signal.

Attempts have been made to design satellite communications systems which rival the performance of SONET-ring networks, particularly for transoceanic applications. One conventional system of this type uses a 72-MHz satellite transponder to convey signals from one point to another on the earth. To support duplex communications, two 72-MHz transponders must be included in the satellite.

Using 72-MHz transponders to support OC-3 signal transmissions represents an inefficient use of frequency spectrum because the bandwidth required to transmit an OC-3 signal is less than 72 Mhz. More specifically, 54 MHz of bandwidth is required to transmit one OC-3 signal. Using a 72-MHz transponder to handle these signals is unnecessarily large and therefore leads to wasted bandwidth and other inefficiencies. Furthermore, 72 MHz transponders have proven to be expensive.

A need therefore exists for an improved method for transmitting high-speed signals over a satellite communications system, and more particularly one which makes more efficient use of frequency spectrum without sacrificing transmission speed, bandwidth, and other requirements needed to rival the performance of fiber-optic communications systems.

### SUMMARY OF THE INVENTION

The present invention is a system and method for communicating high-speed signals over a satellite communications system in away that makes more efficient use of bandwidth compared with conventional systems and methods. In accordance with one embodiment, the method converts an optical signal having a first bit-rate format into a plurality of optical signals, each having a bit-rate format smaller than the first bit-rate format. As a result, the bit-rate formats of the converted optical signals have smaller transmission bandwidths than the first bit-rate format. The converted optical signals are then converted to electrical signals, which are then transmitted to a communications satellite over a predetermined frequency band. The converted optical signals may all have the same bit-rate format and bandwidth. To convey the signals to an intended destination, the satellite includes a first transponder having a bandwidth which may be substantially equal to the bandwidth of a subset of the transmitted signals. A second transponder handles transmission of the remaining signals.

In accordance with a more specific embodiment of the invention, the first and second satellite transponders are 36 MHz transponders. Given these parameters, the method proceeds by receiving an OC-3 signal from an optical communications network. A conversion circuit on the transmitting side of the system converts the OC-3 signal into three OC-1 signals. The conversion therefore turns a single signal having a 155.52 Mbps data rate into three signals each having a 51.84 Mbps bit rate and 18 MHz in bandwidth. The OC-1 signals are then converted into electrical signals and transmitted to the satellite. In the satellite, one 36 MHz transponder conveys two of the 18-MHz signals to a receiver and a second 36-MHz transponder conveys the remaining third 18 MHz signal to the receiver.

Converting the OC-3 signal into three OC-1 signals and then transmitting those signals through 36-MHz transponders allows the present invention to outperform conventional systems which use 72 MHz transponders. For example, a bandwidth of only 54-MHz is required to transmit the OC-1 signals compared with 72 MHz of bandwidth for conventional systems. The invention therefore makes a more efficient use of frequency spectrum. In another embodiment, duplex communications are performed with three 36-MHz transponders. Here, 108 MHz of bandwidth is used compared with 144 MHZ which a conventional system would require to achieve comparable performance.

### BRIEF DESCRIPTION OF THE DRAWINGS

FIG. 1 is a diagram of an OC-3 signal format which is typically used to transmit broadband, high-speed data signal through a fiber-optic communications system.

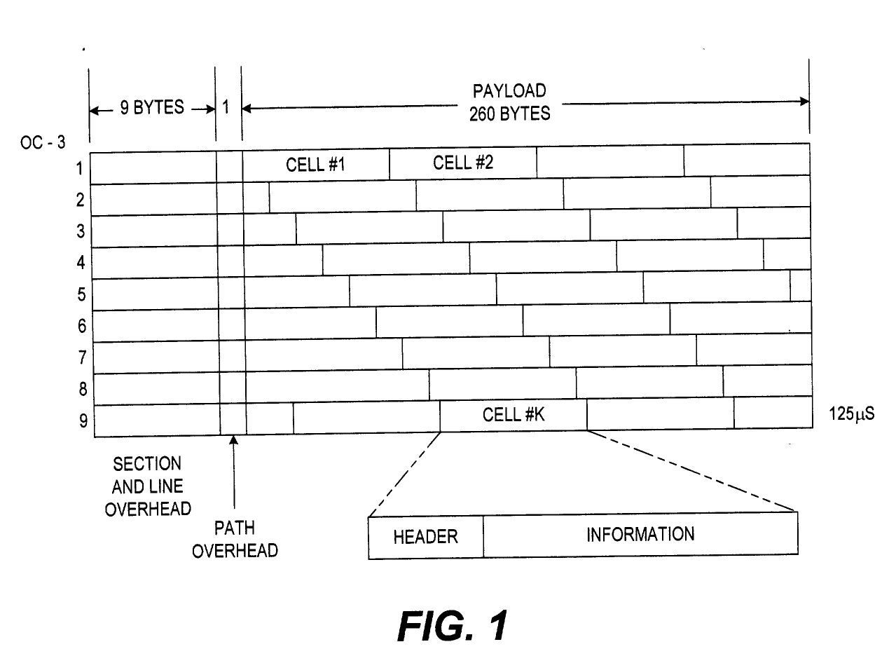

FIG. 2 is a diagram of one embodiment of the satellite communications system of the present invention configured for simplex communications.

FIG. 3 is a diagram showing exemplary configurations of the converter unit and ground communications equipment shown in FIG. 2

FIG. 4 is a flow diagram showing steps included in one embodiment of the method of the present invention for communicating broadband, high-bit rate signals through a satellite.

FIG. 5 is a diagram comparing a signal transmission performed in accordance with one embodiment of the present invention with a signal transmission performed in accordance with a conventional satellite communications method.

FIG. 6 is a diagram of another embodiment of a satellite communications system of the present invention configured for duplex communications.

FIG. 7 is a diagram of another embodiment of a satellite communications system of the present invention configured for duplex communications.

FIG. 8 is a diagram of another embodiment of a satellite communications system of the present invention configured for duplex communications.

### DESCRIPTION OF THE PREFERRED EMBODIMENTS

The present invention is a satellite communications system which interfaces with an optical communications system for purposes of transmitting voice, data, and/or other forms of digital information. The optical system may be a cable television system, a telecommunications system, a defense-related system, or any of a variety of other systems which transmit information from one point to another on the earth. To meet rising demands for high-bandwidth communications, at least one embodiment of the invention transmits converted optical signals having high data-rate formats over satellites that are configured with more modest transponder specifications. The invention is therefore beneficial because it allows high data-rate transmissions to take place in an efficient and cost-effective manner using existing transponders.

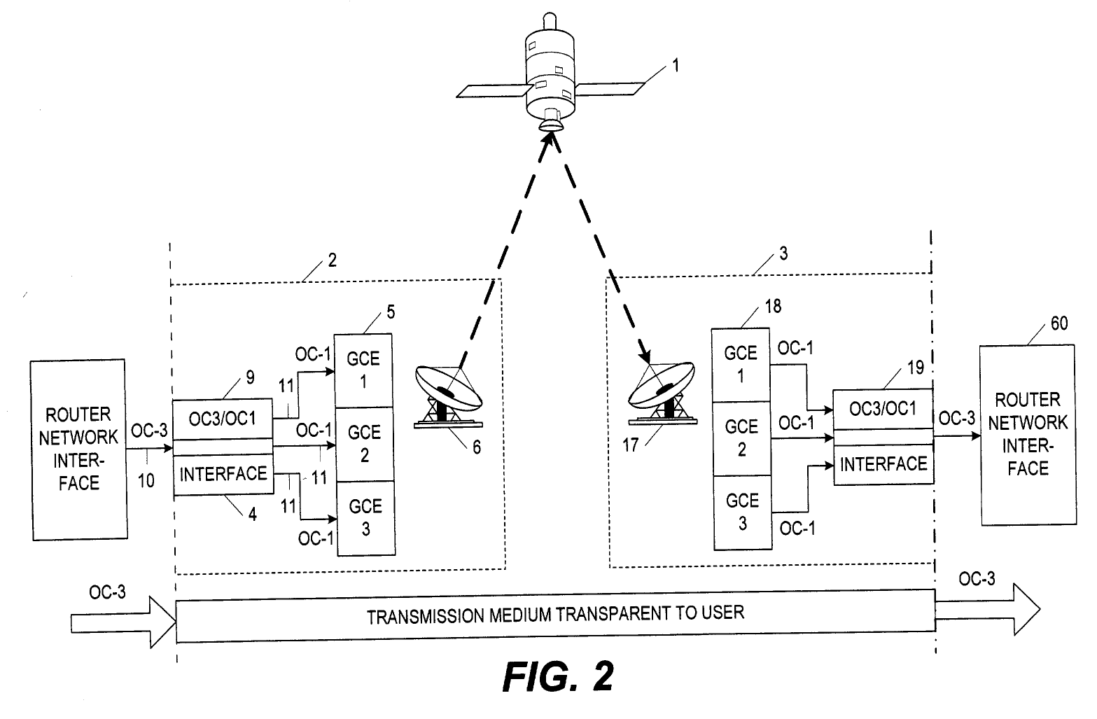

FIG. 2 shows a preferred embodiment of the satellite communications system of the present invention configured for simplex (one-way) transmissions. The system includes a satellite 1 which links a transmission side 2 to a reception side 3. The transmission side is connected to a router network interface of an optical communications system. The optical communications system is preferably one which carries optical signals having high data-rate formats. In accordance with one advantageous feature of the invention, the optical system carries signals which adhere to the OC-3 format used for transmitting data, voice, images, and other broadband signals. Those skilled in the art can appreciate, however, that the optical system may also carry signals which support higher or lower data rates. For example, the optical system may transmit signals having any multiple of the OC-1 data rate (51.84 Mbps). Accordingly, as will be discussed in greater detail below, the system of the present invention may transmit signals through a satellite which corresponds to any multiple of the STS-1 rate, which is the electrical-signal counterpart to OC-1.

The transmission side of the present invention includes an interface circuit 4, ground communications equipment 5, and a transmit antenna 6. The interface circuit includes a converter unit 9 which converts an optical signal 10 received in a high bit-rate format into a plurality of optical signals 11 having different bit-rate formats, and more specifically ones which have smaller transmission bandwidths than the transmission bandwidth of the input optical signal. The bit-rate format of optical signals 11 may differ from one another or may be the same. In accordance with one particularly desirable feature of the invention, if the input optical signal is in an OC-3 data format converter 9 converts the signal into a plurality of OC-1 optical signals.

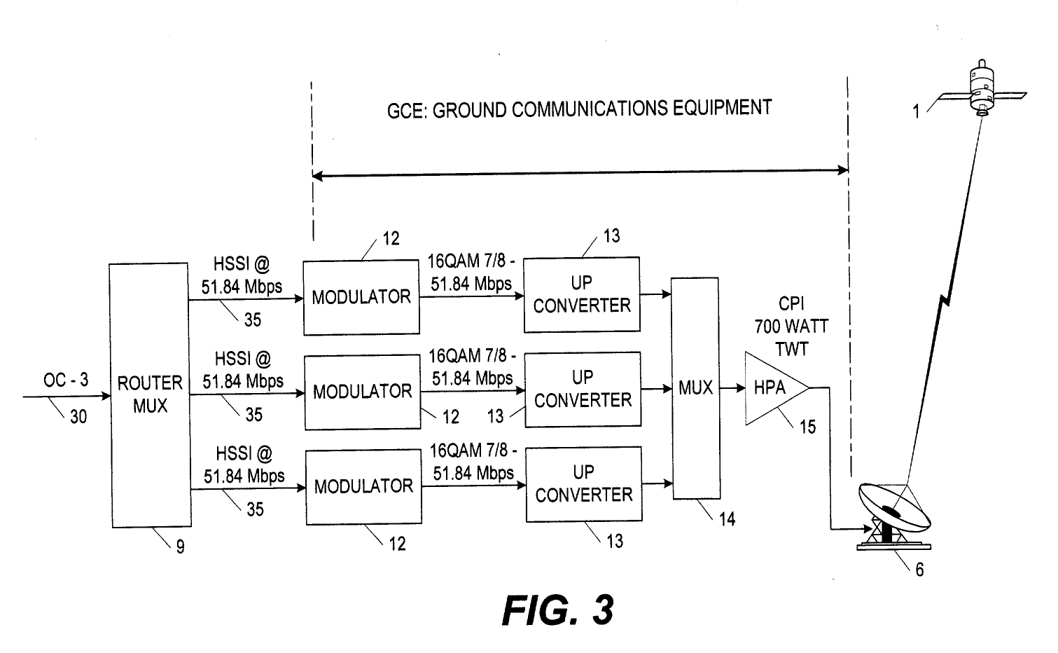

FIG. 3 shows exemplary configurations of the converter unit and ground communications equipment shown in FIG. 2. In this example, an input OC-3 optical signal 30 is channel mapped to a router multiplexer (e.g., a Cisco 7200 router) which includes the converter unit of the invention. The converter unit converts the input OC-3 signal into three OC-1 optical signals 35 each of which adheres to a 51.84 Mbps format. Preferably, the router multiplexer includes an optical-to-electrical converter which converts the OC-1 signals into STS-1 electrical signals having a 51.84 Mbps format. The number and type of signals output from the converter unit preferably depends on the number of transponders in the satellite and their operating characteristics. For reasons that will become apparent below, the conversion shown in FIG. 3 is performed for a satellite which has two transponders each with a 36 MHZ operating bandwidth.

The ground communications equipment is configured to receive the signals output from the converter unit. In this example, the ground communications equipment includes three modulator units 12 connected to three up-converter circuits 13. The modulator units respectively modulate the three STS-1 (or OC-1) signals output from the converter up to an intermediate frequency (IF). The modulation may be any type conventionally used for transmitting satellite signals including but not limited to quadrature amplitude modulation (QAM). Preferably, the invention performs 16QAM 7/8. modulation. As those skilled in the art can appreciate, 16 QAM modulation involves taking four bits of digital information at a time from a serial data stream and then representing those bits as one symbol. Each symbol may be described as a phase and amplitude shift applied to a carrier signal. The “⅞” fraction refers to the Forward Error Correction (FEC) ratio. This type of error correction involves inserting parity bits into the data stream just before transmitting it to the satellite. The satellite receiver or demodulator removes these parity bits and applies them to an algorithm. The algorithm, or decoding schemes (which may be Trellis coding in accordance with one aspect of the present invention), corrects bit errors encountered during transmission. The ⅞ fraction means that seven out of eight bits are payload data and one bit is parity. In this example, if OC-1 signals are output from the router multiplexer, converter circuits may be included at any position before, within, or after the modulator circuits for converting the OC-1 signals into electrical signals.

Converter circuits 13 convert the modulated IF signals output from modulators 12 into radio-frequency (RF) signals, which are then combined in multiplexer 14 and amplified by high-power amplifier 15. By way of example, multiplexer 14 may be an RF combiner which combines 6 or 14 GHz signals from each of the up-converters so they may be applied to the amplifier. The combined signals are transmitted to satellite 1 via the ground station transmitter, which, for example, may be an 11-meter antenna. Preferably, the three signals are transmitted simultaneously (in parallel) to the satellite. The satellite uplink maybe within any frequency band known with a C-band uplink being preferable.

Returning to FIG. 2, the reception side of the system includes a receiving antenna 17, ground communications equipment 18, and an interface circuit with a resident router/multiplexer which includes a converter unit 19. The ground communications equipment down converts the received RF signals into three IF signals, which are then demodulated to baseband OC-1 optical or STS-1 electrical signals. The conversion unit converts the three OC-1 optical or STS-1 electrical signals into a single high data-rate, high-bandwidth signal which is then output to a router network interface 60. By way of example, the reception side may therefore receive three electrical (STS-1) signals from the satellite. Converter unit 19 then converts the STS-1 signals into a single OC-3 signal, which is then carried by the optical network to an intended destination. The OC-3 signal may be generated at the reception side by interleaving bytes from three OC-1 signals in accordance with SONET industry standard techniques. The SONET standard is set forth in ANSI specification T1.105 entitled Digital Hierarchy—Optical Interface Rate and Formats Specifications, and technical recommendations may be found in Bellcore GE-253-CORE Synchronous Optical Network (SONET) Transport Systems, the contents of both are incorporated by reference herein.

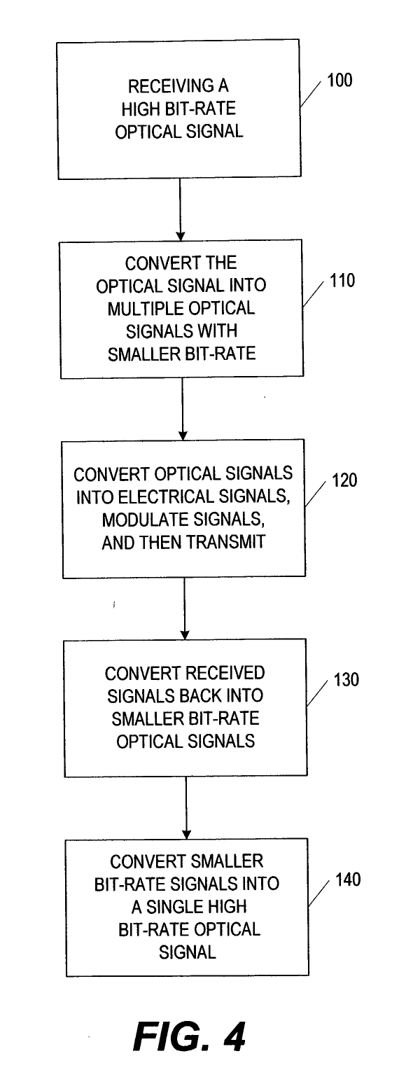

FIG. 4 is a flow diagram showing steps included in a preferred embodiment of the method of the present invention. While the flow diagram pertains to the OC3/OC-1 example previously discussed, other formats may also be converted in accordance with the present invention. The method begins by receiving an OC-3 signal (155.52 Mbps) from an optical network. (Block 100). This signal is then converted into three OC-1 signals each of which are in a 51.84 Mbps format. (Block 110). The OC-1 signals are then converted into electrical (STS-1) signals, modulated to a desired carrier frequency, and simultaneously transmitted to the satellite. (Block 120). Transponders in the satellite convey the signals to the reception side of the system, where they are converted back into STS-1 electrical signals and then into three OC-1 signals. (Block 130). The OC-1 signals are converted back into a single OC-3 signal and transmitted along the optical network. (Block 140).

The conversions performed at the transmission side may be determined based on the transponder equipment included in the satellite. For example, if the satellite includes two C-band transponders with operating bandwidths of 36 MHZ each, then it is desirable for the invention to convert an incoming 155.52 Mbps OC-3 signal into three OC-1 signals of 51.84 Mbps each. The reason for this conversion may be explained as follows.

Transmitting a signal having a bit-rate format of 51.84 Mbps consumes 18 MHZ of bandwidth. Given the constraint that the satellite includes two 36 MHz transponders, the Inventors of the present invention have determined that it is desirable to split the OC-3 signal by an amount which optimizes the bandwidth of these transponders. By splitting the OC-3 signal into three 51.84 Mbps OC-1 signals, it is clear that two of these signals will consume a combined 36 MHz of bandwidth, which corresponds to the entire bandwidth of one of the C-band transponders. The third OC-1 signal is easily handled by the second C-band transponder, and in fact 18 MHz of bandwidth in the second transponder will be left free for other uses.

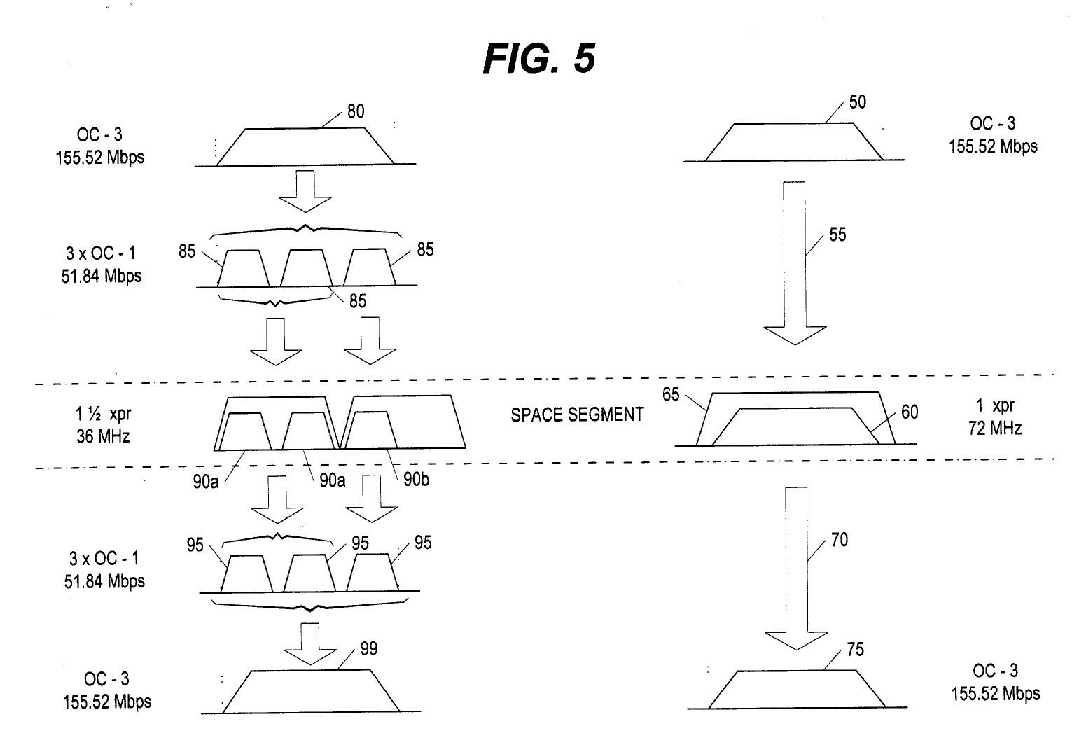

These features of the invention, as well as others, represent a significant improvement over conventional methods for transmitting high-bandwidth signals over satellite systems. FIG. 5 shows a signal transmission comparison which in at least one way makes this improvement apparent. This figure shows two signal flows, one corresponding to the present invention and one corresponding to a conventional method used to transmit high-bandwidth signals to a satellite having a single 72 MHz transponder.

According to the conventional method, an OC-3 signal 50 is transmitted to the satellite without any pre-processing, i.e., the signal is transmitted in one 155.52 Mbps data block. (See arrow 55). From the previous discussion, it is clear that this data block consumes 54 MHZ of transponder bandwidth 60, which is able to be handled by the 72 MHz transponder in the satellite 65. The OC-3 signal is transmitted by this transponder back to earth (see arrow 70) and placed on the optical network in its 155.52 Mbps format 75.

Transmitting an OC-3 signal to the transmitter directly (i.e., without any bitrate format conversion) has been determined to be disadvantageous in a number of respects. For example, direct transmission of the OC-3 signal using 16QAM modulation requires over 56 MHZ of bandwidth. A 72 MHZ transponder would therefore be required to support the resulting signal. Many satellites already in use do not have 72 MHZ transponders, and therefore must come up with alternative solutions for handling these signals if it is even possible. Also, satellites which are equipped with 72 MHZ transponders only have a limited number of them. Using these transponders to handle the aforementioned types of signals therefore does not constitute the most efficient use of transponder capacity.

The method of the present invention overcomes the drawbacks of the conventional method. In accordance with the present invention, an OC-3 signal 80 is converted into three OC-1 signals 85, each of which corresponds to the OC-1 (51.84 Mbps) format. The OC-1 signals are then converted into STS-1 electrical signals, modulated, and simultaneously transmitted to a satellite which has two transponders, each having, for example, 36 MHZ of operating bandwidth. Two of the STS-1 signals 90a (e.g. 18 MHZ each) are handled by one transponder and the other STS-1 signal 90b (18 MHZ) is handled by the other transponder. The transponders transmit these signals to a receiving antenna, where they are converted back into optical OC-1 signals 95 and then combined to form the original OC-3 signal 99.

Converting an OC-3 signal into multiple OC-1 signals prior to transmission results in the following advantages. First, the invention transmits the same information in less transponder bandwidth compared with conventional systems. For example, the invention transmits in 54 MHZ of bandwidth (corresponding to the content of 3° C.-1/STS-1 signals) what it would take a conventional system to transmit in 72-MHZ of bandwidth, in the situation where the conventional system was transmitting the content of a single OC-3 signal to a satellite having a 72 MHZ transponder.

Second, because the invention converts an OC-3 signal into three STS-1 components, each requiring 16.04 MHZ of bandwidth, the present invention transmits the content of an OC-3 signal using one and a half standard 36 MHZ satellite transponders, instead of the more expensive 72 MHZ transponders. The invention thus lowers the cost of the satellite system while simultaneously improving communications speed. Also, because many satellites in use today are equipped with 36 MHZ transponders, the invention is more widely applicable than conventional methods.

Third, the present invention transmits all SONET overhead information through the satellite. Nothing is removed prior to transmission.

Fourth, the present invention is more robust than the conventional system. For example, if one of the STS-1 signals were to fail, the remaining two signals would continue to support traffic. This has been verified by on satellite testing.

Fifth, the present invention may operate using standard fiber-optic interfaces. Unlike many conventional systems, no adapters or converters are necessary in order to interface with the optical communications system.

The conversion of an OC-3 signal into three OC-1 signals of 51.84 Mbps each corresponds to a preferred embodiment of the invention. Other variations may are possible given the hardware requirements of the satellite and/or desired data rate requirements. For example, the system of the present invention may function as a satellite-based SONET hub. In this embodiment, OC-1 (STS-1) data streams may be added or dropped at the multiplexer. The terrestrial rates (OC-1, OC-3, or OC-12) would be a function of a terrestrial transport mechanisms. Moreover, division and conversion steps of the present invention allow the invention to support any increment of the OC-1 (STS-1) data rate.

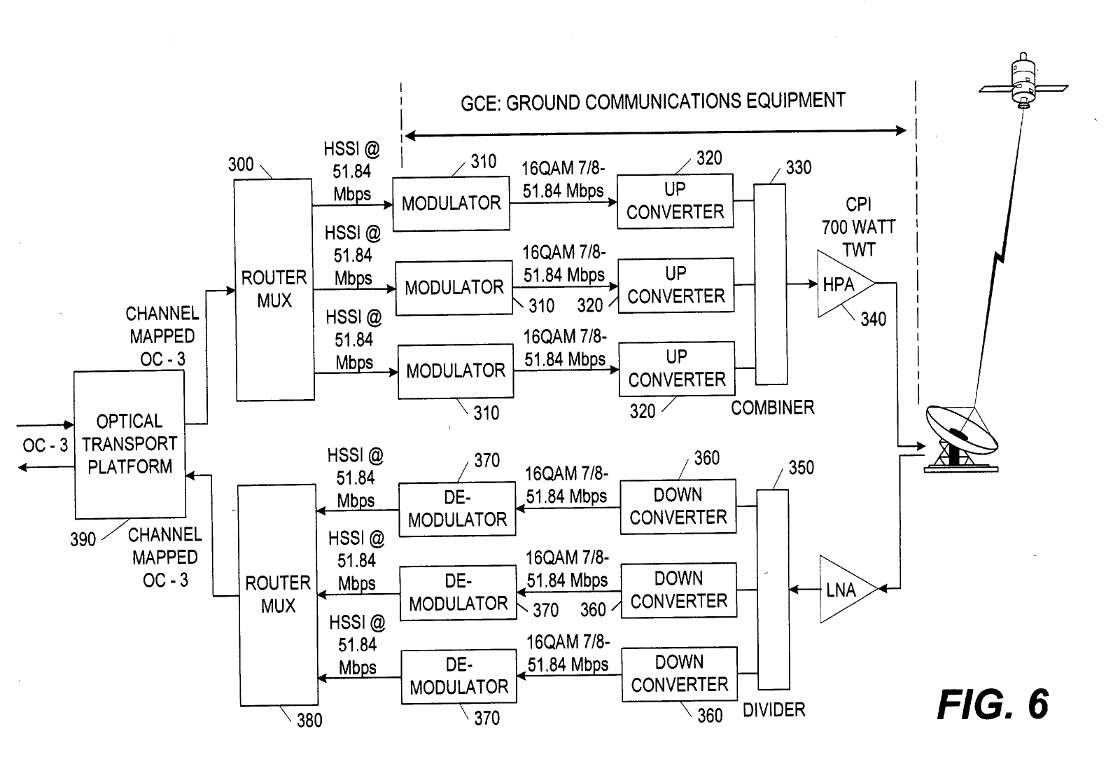

FIG. 6 shows an embodiment of the satellite communications system of the present invention configured for duplex (two-way) transmissions. The duplex embodiment is similar to the simplex embodiment, except that both sides of the system have transmitting and receiving circuits. As shown, a router multiplexer 300 converts the high-bandwidth signals received from an optical network into smaller-bandwidth signals. The high-bandwidth signal may be an OC-3 signal and the smaller-bandwidth signals may be OC-1 signals. The OC-1 signals are then converted into respective STS-1 signals, modulated by modulators 310 using 16QAM 7/8 modulation, up-converted by up-converters 320, multiplexed by multiplexer 330, and then amplified by amplifier 340 prior to transmission.

On the reception side, a divider 350 divides an RF signal received from the satellite and down-converters 360 convert the divided RF signals into respective IF signals. The IF signals are then demodulated to baseband STS-1 signals by demodulators 370. A network router multiplexer 380 converts the smaller-bandwidth STS-1 signals into respective OC-1 optical signals, and then into one higher-bandwidth signal such as an OC-3 signal. Finally, an optical transport platform 390 passes the OC-3 signal through an optical communications network to its intended destination. By way of illustration only, the hub circuit may be a Cisco Fiber Multiplex/SONET hub.

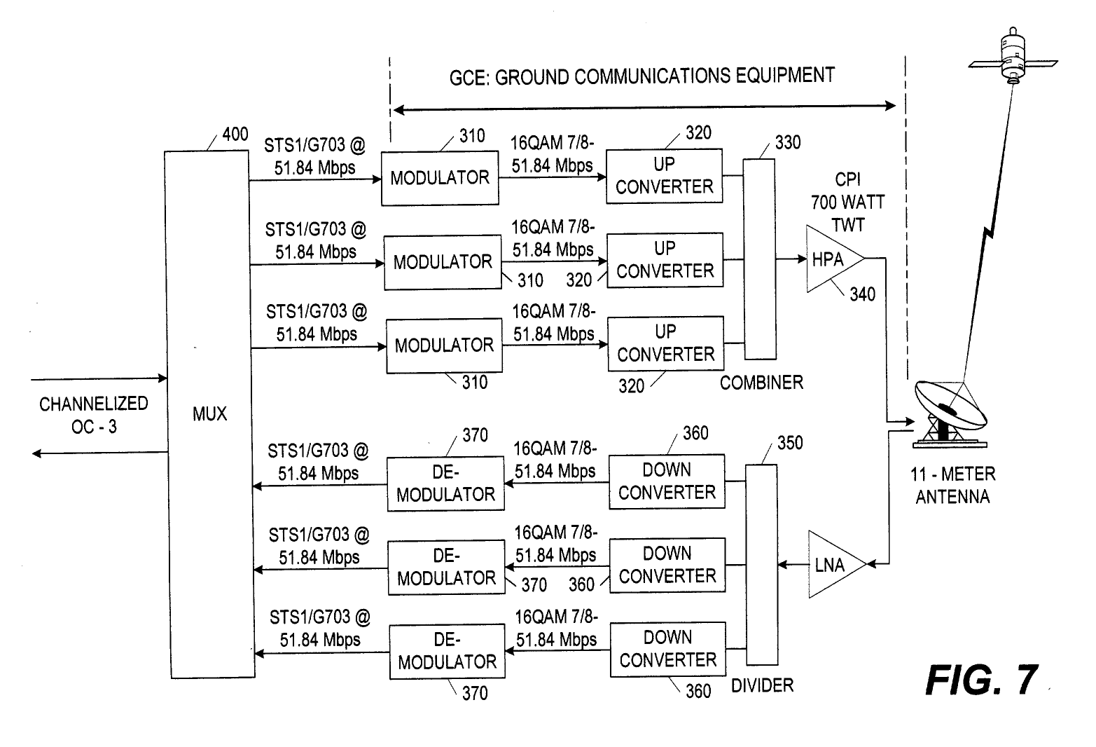

FIG. 7 shows another embodiment of the satellite communications system of the present invention configured for duplex communications. In this embodiment, the network routers in both the transmission and reception circuits are replaced with a single multiplexer circuit 400 which not only performs the routing required to and from the optical network but also performs conversions required for transmission and reception. For example, multiplexer circuit 400 may be an Oasys Telecom Mini Mux 155 multiplexer which converts an OC-3 carrier received at its fiber-optic input into STS-1 components.

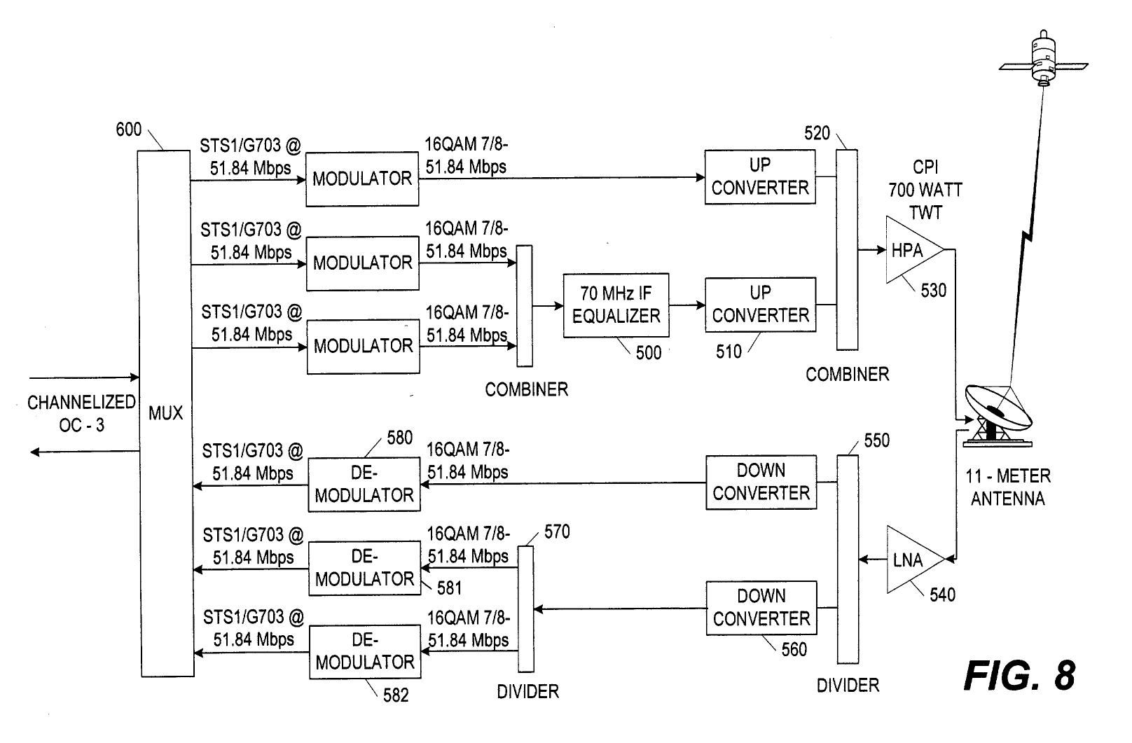

FIG. 8 shows another embodiment of the satellite communications system of the present invention configured for duplex communications. This embodiment is similar to the embodiment of FIG. 7 except that, on the transmission side, two of the modulated STS-1 signals are equalized in a 70 MHZ equalizer 500, converted to an RF signal in up-converter 510, and then combined with the third modulated and converted STS-1 signal in combiner 520. The high-gain amplifier 530 maybe a CPI 700 watt TWT amplifier. On the reception side, an RF signal received from the satellite is amplified by low-noise amplifier 540 and then divided into two signals by divider 550. Down-converters 560 convert the divided signals into respective 51.84 Mbps and 103.68 Mbps signals. The 51.84 Mbps signal is directly input into a demodulator 580 where it is demodulated. The 103.68 Mbps signal is divided by divider 570 into two 51.84 Mbps signals, which are respectively demodulated by demodulators 581 and 582. The three signals output from the demodulators are STS-1 electrical signals at 51.84 Mbps. These STS-1 signals are converted back into the originally transmitted OC-3 signal in multiplexer 600.

The duplex embodiment of the invention achieves potentially greater advantages than the simplex embodiments. For example, as previously stated in order to support duplex transmissions a total of 54-MHz of bandwidth is required both ways. (In the duplex embodiment, the 18-MHz left free in the second transponder is now used to return signals to the transmitter.) The total bandwidth requirement is therefore 108 MHz. This is substantially smaller than a conventional satellite system, since such a system requires two 72-MHz transponders which consume a substantially larger operating bandwidth of 144 MHz. This savings in bandwidth not only improves the operating efficiency of the satellite system, it potentially reduces power and may translate into improved costs.

Other modifications and variations to the invention will be apparent to those skilled in the art from the foregoing disclosure. Thus, while only certain embodiments of the invention have been specifically described herein, it will be apparent that numerous modifications may be made thereto without departing from the spirit and scope of the invention.

We claim:

1. A method for communicating signals, comprising:
splitting an optical signal having a first bit-rate format into a plurality of signals each having a bit-rate format smaller than the first bit-rate format, wherein the bit-rate formats of said plurality of signals have smaller transmission bandwidths than said first bit-rate format; and
transmitting said plurality of signals to a satellite.

2. The method of claim 1, wherein said plurality of optical signals have a same bit-rate format.

3. The method of claim 2, wherein said plurality of optical signals have equal transmission bandwidths.

4. The method of claim 1, wherein said satellite includes a first transponder which has an operating bandwidth sufficient to receive two of said plurality of signals and a second transponder having an operating bandwidth sufficient to receive a third one of said plurality of signals.

5. The method of claim 4, wherein each of said two signals has a transmission bandwidth equal to one-half the operating bandwidth of said first transponder.

6. The method of claim 5, wherein the operating bandwidth of said first transponder is 36 MHz, and wherein each of said two signals has a transmission bandwidth of 18 MHz.

7. The method of claim 6, wherein the operating bandwidth of said second transponder is 36 MHz, and wherein the third one of said signals has a transmission bandwidth of 18 MHz.

8. The method of claim 1, wherein said optical signal is an OC-3 signal and said plurality of signals are OC-1 signals, and wherein said method further includes converting each of said OC-1 signals into STS-1 electrical signals to be transmitted in said transmitting step.

9. The method of claim 1, wherein said splitting step is performed in a network router.

10. The method of claim 1, wherein said transmitting step includes simultaneously transmitting said plurality of signals to said satellite.

11. A method for communicating with a satellite, comprising:
splitting an OC-3 signal into three OC-1 signals;
converting the three OC-1 signals into electrical signals; and
transmitting said electrical signals to a satellite.

12. The method of claim 13, wherein each of said OC-1 signals has a transmission bandwidth of 18 MHz, and wherein said satellite includes a first transponder having an operating bandwidth of 36 MHz which receives two of said electrical signals and a second transponder having an operating bandwidth of 36 MHz which receives a third one of said electrical signals.

13. The method of claim 11, wherein, in the transmitting step, said electrical signals are transmitted to said satellite in parallel.

14. The method of claim 11, further comprising:
combining two of said electrical signals to form a first combined signal; and
combining the first combined signal with a third one of said electrical signals to form a second combined signal, wherein said second combined signal is transmitted in said transmitting step.

15. A signal transmission system, comprising:
a splitter which splits an optical signal having a first bit-rate format into a plurality of signals each having a bit-rate format smaller than the first bit-rate format, wherein the bit-rate formats of said plurality of signals have smaller transmission bandwidths than said first bit-rate format; and
a transmitter which transmits said plurality of signals.

16. The system of claim 15, wherein said plurality of signals have a same bit-rate format.

17. The system of claim 16, wherein said plurality of signals have equal transmission bandwidths.

18. The system of claim 15, further comprising:
a satellite for receiving said plurality of signals transmitted from said transmitter.

19. The system of claim 18, wherein said satellite includes a first transponder having an operating bandwidth sufficient to receive two of said plurality of signals and a second transponder having an operating bandwidth sufficient to receive a third one of said plurality of signals.

20. The system of claim 19, wherein each of said two signals has a transmission bandwidth equal to one-half the operating bandwidth of said first transponder.

21. The system of claim 20, wherein the operating bandwidth of said first transponder is 36 MHz, and wherein the transmission bandwidth of each of said two signals is 18 MHz.

22. The system of claim 21, wherein the operating bandwidth of said second transponder is 36 MHz, and wherein the third one of said signals has a transmission bandwidth of 18 MHz.

23. The system of claim 15, wherein said optical signal is an OC-3 signal and said plurality of signals are OC-1 signals, and wherein said system further includes a converter which converts each of said OC-1 signals into STS-1 electrical signals.

24. The system of claim 23, further comprising:
a satellite for receiving said plurality of signals transmitted from said transmitter,
wherein said satellite includes a first transponder having an operating bandwidth sufficient to receive two of said STS-1 electrical signals and a second transponder having an operating bandwidth sufficient to receive a third one of said STS-1 electrical signals.

25. The system of claim 24, wherein each of said two STS-1 electrical signals has a transmission bandwidth equal to one-half an operating bandwidth of said first transponder.

26. The system of claim 15, wherein said splitter is included in a network router.

27. The system of claim 15, wherein said transmitter simultaneously transmits said plurality of signals.

28. A satellite communications system, comprising:
a splitter which splits an OC-3 signal into three OC-1 signals;
a converter which converts the three OC-1 signals into electrical signals; and
a transmitter transmits the electrical signals.

29. The system of claim 28, further comprising:
a satellite for receiving said plurality of electrical signals transmitted from said transmitter.

30. The system of claim 29, wherein each of said OC-1 signals has a transmission bandwidth of 18 MHz, and wherein said satellite includes a first transponder having an operating bandwidth of 36 MHz which receives two of said converted OC-1 electrical signals and a second transponder having an operating bandwidth of 36 MHz which receives a third one of said converted OC-1 electrical signals.
